(19) United States
(12) Patent Application Publication
(10) Pub. No.: US 2007/0149210 A1
(43) Pub. Date: Jun. 28, 2007

(54) Location-based services in wireless networks

(75) Inventors: Kevin W. McKiou, Naperville, IL (US); Arun Sankisa, Chicago, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/317,144

(22) Filed: Dec. 23, 2005

(51) Int. Cl. H04Q 7/20

(52) U.S. Cl. 455/456.1

(57) ABSTRACT

Wireless networks, mobile devices, and associated methods are disclosed that provide a location-based service to a requesting mobile subscriber. The location-based service allows a requesting mobile subscriber to identify other mobile subscribers in a geographic area, such as in the proximity of the user or another designated area. To implement the service, a wireless network transmits processes location information for mobile subscribers of the wireless network to identify other mobile subscribers in the geographic area. The wireless network then transmits the location information for the other mobile subscribers to the mobile device of the requesting mobile subscriber. The mobile device then indicates the other mobile subscribers in the geographic area to the requesting mobile subscriber, such as by displaying a list or displaying the other mobile subscribers on a map. The requesting mobile subscriber may then initiate any form of voice or data communication with the other mobile subscribers.

### RELATED APPLICATIONS

This patent application is related to a co-pending patent application having the Ser. No. 10/953,740, filed on Sep. 29, 2004, which is incorporated herein by reference.

### BACKGROUND OF THE INVENTION

1. Field of the Invention

The invention is related to the field of communications, and in particular, to providing location-based services to mobile subscribers of a wireless network. More particularly, the location-based service described herein allows a mobile subscriber to identify other mobile subscribers in a geographic area, and initiate communication with one or more of the other mobile subscribers.

2. Statement of the Problem

Cellular phones, PCS phones, and other mobile wireless data devices have become very popular due to the conveniences that they provide to people. Wireless devices have become compact in size, which make them easy and convenient to carry. People routinely carry their cell phones or wireless PDAs with them on their belt, in their pocket, in their purse, etc, so they are available for use at any time.

Because of the large demand for wireless voice and data services, service providers strive to offer new services to current and potential customers. Some exemplary services are text messaging, digital pictures, web browsing, etc. A new trend for service providers is to provide location-based services. The location-based services provide information to a subscriber based on the location of the subscriber. For instance, the location-based services may send informational text messages to the subscriber's phone, such as information on the weather, information on traffic reports, advertisements, etc, based on the location of the subscriber.

Another location-based service allows a user to track the location of one or more individuals defined in a “buddy list” through their wireless device. Although this service may be useful, it also requires the user to generate and maintain the buddy list. The user thus has to know the individuals he/she is programming into the buddy list, and their phone number, email address, etc. A user may want to identify and/or communicate with other individuals, groups, businesses, and services in his/her vicinity or another geographic area regardless of whether the user has programmed them into his/her buddy list.

### SUMMARY OF THE SOLUTION

The invention solves the above problems and other problems by providing a location-based service that allows a mobile subscriber to identify other mobile subscribers in a geographic area, and initiate communication with one or more of the other mobile subscribers. The location-based service may also provide an indication of the communication capabilities of the other mobile subscribers. Advantageously, the mobile subscriber requesting the location-based service can determine the other mobile subscribers that are in his/her vicinity, and how to communicate with those other subscribers. The requesting mobile subscriber can also determine the other mobile subscribers that are in another geographic area remote from the requesting mobile subscriber, and how to communicate with those other subscribers. The requesting mobile subscriber does not have to maintain a buddy list to receive the service, as the wireless network or the mobile device automatically determines what other mobile subscribers are in the geographic area and indicates those other mobile subscribes to the requesting mobile subscriber. The location-based service advantageously expands the number of individuals the requesting mobile subscriber can communicate with, even to individuals for which the requesting mobile subscriber did not previously know their phone number, email address, webpage, etc.

One embodiment of the invention comprises a method of operating a wireless network to provide the location-based service to a mobile subscriber requesting the service (referred to as the requesting mobile subscriber). A location-based service system (referred to as service system) receives location information for the mobile subscribers of the wireless network from one or more network nodes. Location information comprises any information on the geographic location of a mobile subscriber, such as a latitude/longitude of a mobile subscriber, a physical address of a mobile subscriber, etc. The service system processes the location information to identify other mobile subscribers in a particular geographic area. For instance, the geographic area may be a geographic area proximate to or in the proximity of the requesting mobile subscriber, or another geographic area designated by the requesting mobile subscriber. The service system then transmits the location information for the other mobile subscribers identified to be in the geographic area to the mobile device of the requesting mobile subscriber. For instance, the service system may generate an HTML file indicating the location information for the other mobile subscribers, and transmit the HTML file to the mobile device of the requesting mobile subscriber. The mobile device may then indicate to the requesting mobile subscriber, the other mobile subscribers in the geographic area, such as by displaying the HTLM web page.

Other embodiments comprise mobile devices and associated methods for providing the location-based services. A mobile device of the requesting mobile subscriber is adapted to receive the location information from the wireless network. The mobile device is further adapted to process the location information to identify the other mobile subscribers in a particular geographic area. The mobile device is further adapted to indicate the other mobile subscribers in the geographic area to the requesting mobile subscriber, such as by displaying a list of the other mobile subscribers or by displaying the other mobile subscribers on a map. The requesting mobile subscriber may then select one or more of the other mobile subscribers, and the mobile device is further adapted to initiate communication with the selected other mobile subscriber.

The mobile device may be further adapted to receive subscriber information from the wireless network indicating the communication capabilities of the other mobile subscribers. The mobile device may then indicate the communication capabilities of the other mobile subscribers to the requesting mobile subscriber. Examples of communication capabilities include voice capabilities, text messaging capabilities, instant messaging capabilities, chat room capabilities, web log capabilities, web page capabilities, etc. The requesting mobile subscriber can thus choose how to initiate communication with the other mobile subscribers based on their communication capabilities.

The invention may include other exemplary embodiments described below.

### DESCRIPTION OF THE DRAWINGS

The same reference number represents the same element on all drawings.

FIG. 1 illustrates a wireless network in an exemplary embodiment of the invention.

FIG. 2 is a flow chart illustrating a method of operating the wireless network to provide the location-based service in an exemplary embodiment of the invention.

FIG. 3 illustrates a mobile device in an exemplary embodiment of the invention.

FIG. 4 is a flow chart illustrating a method of operating the mobile device in an exemplary embodiment of the invention.

FIG. 5 illustrates an exemplary screen displayed by the mobile device in implementing the location-based service described herein.

FIG. 6 illustrates another exemplary screen displayed by the mobile device in implementing the location-based service described herein.

### DETAILED DESCRIPTION OF THE INVENTION

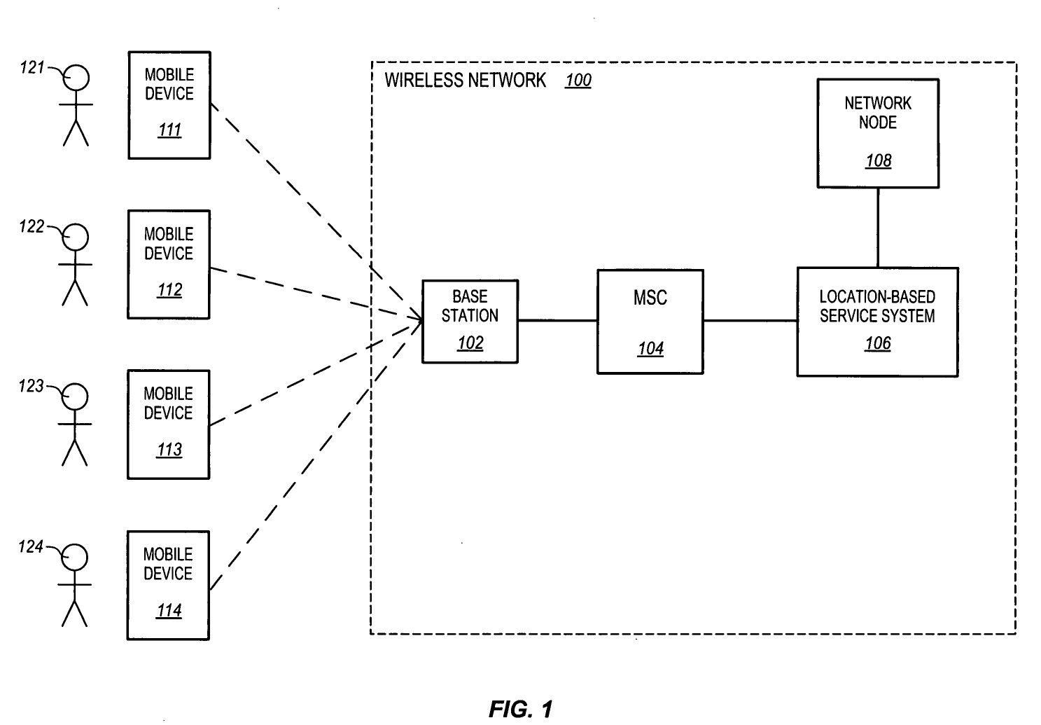

FIGS. 1-6 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below may be combined in various ways to form multiple variations of the invention. As a result, the invention is not limited to the specific embodiments described below, but only by the claims and their equivalents.

FIG. 1 illustrates a wireless network 100 in an exemplary embodiment of the invention. Wireless network 100 comprises any wireless network for providing voice and/or data communications, such as a cellular network, a PCS network, etc. Wireless network 100 includes a base station 102, a Mobile Switching Center (MSC) 104, a location-based service system 106 (referred to herein as service system 106), and one or more network nodes 108. Base station 102 is configured to provide wireless service to a plurality of mobile devices 111-114, and a plurality of other mobile devices not shown. Base station 102 may communicate with mobile devices 111-114 using Code Division Multiple Access (CDMA), Time Division Multiple Access (TDMA), Global System for Mobile Communication (GSM), Universal Mobile Telecommunications System (UMTS), 802.11 WiFi, BlueTooth (Registered), satellite, packet radio, or another protocol. Wireless network 100 may include many other base stations (not shown) to provide service to many mobile subscribers (not shown). Mobile devices 111-114 comprise any devices or systems configured to communicate via wireless signals, such as a cell phone, a PDA, etc. Mobile devices 111-114 are operated by mobile subscribers 121-124, respectively. Wireless network 100 may include other devices, systems, or components not shown in FIG. 1, such as additional base stations, additional MSCs, a Home Location Register (HLR), etc. Wireless network 100 may have interconnections not shown in FIG. 1. For example, network node 108 may also be connected to MSC 104, base station 102, or other network nodes not shown.

According to features and aspects herein, wireless network 100 is adapted to provide a location-based service to mobile subscribers 121-124. The location-based service allows a mobile subscriber to identify other mobile subscribers in his/her vicinity or another geographic area, and initiate communication with one or more of the other mobile subscribers. Assume that mobile subscriber 121 requests the location-based service from wireless network 100.

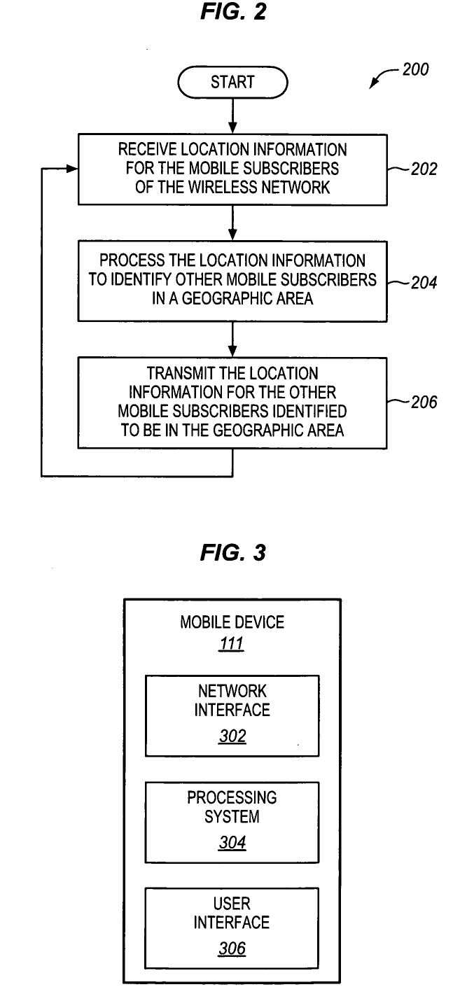

FIG. 2 is a flow chart illustrating a method 200 of operating wireless network 100 to provide the location-based service in an exemplary embodiment of the invention. The steps of method 200 will be described with reference to wireless network 100 in FIG. 1. The steps of the flow chart in FIG. 2 are not all inclusive and may include other steps not shown.

In step 202, service system 106 receives location information for the mobile subscribers 121-124, and possibly other mobile subscribers of wireless network 100, from network node 108 (and possibly other network nodes). Location information comprises any information on the geographic location of a mobile subscriber, such as a latitude/longitude of a mobile subscriber, a physical address of a mobile subscriber, etc. Wireless networks 100 traditionally determine and store location information of mobile subscribers in one or more network nodes 108, such as to provide locations of mobile subscribers to E911 services. Network node 108 may receive the location information from GPS-enabled mobile devices. Network node 108 may alternatively determine the location information by using techniques such as triangulation. Network node 108 may transmit the location information for all of the mobile subscribers of wireless network 100 to service system 106. Network node 108 may alternatively transmit the location information for the mobile subscribers that subscribe to the location-based service to service system 106, thus giving the service provider permission to use their location information.

In step 204, service system 106 processes the location information to identify other mobile subscribers 122-124 in a geographic area. The geographic area may be defined by being a geographic area proximate to (or in a proximity of) and/or surrounding mobile subscriber 121. In such an embodiment, the service system 106 can dynamically determine the geographic area based on the location of mobile subscriber 121. The geographic area may alternatively be remote from mobile subscriber as designated by mobile subscriber 121. For instance, mobile subscriber 121 can enter a point of interest, such as an address or landmark, and service system 106 automatically determines the geographic area based on the designated point of interest.

The size of the geographic area may depend on the location of the geographic area. For instance, if the geographic area is in a large city, then the size of the geographic area may be about a city block. If the geographic area is in a rural area, then the size of the geographic area may be a square mile or more. The size of the geographic area used by service system 106 may be set and provided by mobile subscriber 121. The size of the geographic area may alternatively be dynamically determined by service system 106 based on the number of other mobile subscribers found to be in the geographic area. For instance, if the geographic area is initially a square mile, service system 106 may find thousands of other mobile subscribers in this geographic area, especially if mobile subscriber 121 is in a large city. This number of other mobile subscribers may be more than mobile device 111 could display to mobile subscriber 121. Thus, service system 106 may reduce the size of the geographic area until the number of other mobile subscribers identified is less than a threshold number, such as 10, 20, 50, etc.

In identifying the other mobile subscribers 122-124 in the geographic area in step 204, service system 106 may first determine the location of mobile subscriber 121 or the point of interest as designated by mobile subscriber 121. Service system 106 may then define the geographic area around mobile subscriber 121 or the designated point of interest. Service system 106 then determines one or more other mobile subscribers 122-124 that are in the geographic area. As stated above, the size of the geographic area may depend on the number of other subscribers found to be in the geographic area.

In step 206, service system 106 transmits the location information for the other mobile subscribers 122-124 identified to be in the geographic area to mobile device 111. Service system 106 transmits the location information to mobile device 111 through MSC 104 and base station 102. Service system 106 may transmit the location information in any desired signaling message or data message. For instance, service system 106 may transmit the location information in the form of an HTML file that may be displayed by mobile device 111 as a web page. The HTML file may indicate the location of the other mobile subscriber 122-124 such as on a map, in a list, etc.

In some embodiments, service system 106 may additionally determine communication capabilities of the other mobile subscribers 122-124. Network node 108 or other systems or servers in wireless network 100 store information on the communication capabilities of mobile devices 111-114. Communication capabilities may include voice capabilities, text messaging capabilities, instant messaging capabilities, chat room capabilities, web log capabilities, web page capabilities, etc. Mobile subscribers 121-124 may register the capabilities of their mobile devices 111-114 when registering for the service. Alternatively, wireless network 100 may be able to determine the communication capabilities of mobile devices 111-114. Service system 106 transmits subscriber information to mobile device 111 indicating the communication capabilities of the other mobile subscribers 122-124.

The subscriber information may include information on communicating with a particular mobile device or mobile subscriber. For instance, if a communication capability of mobile subscriber 122 is voice, then the subscriber information may also include a phone number for mobile subscriber 122. The phone number may only be displayed if mobile subscriber 122 allows for that information to be shared. For privacy reasons, mobile subscriber 122 may choose not to share a number or display voice (or any other) communication capability. In the case where voice communication is available, but the number is not displayed, mobile subscriber 121 would still be able initiate a call. Wireless network 100 will place the call internally without divulging any private information. Additionally, even when the phone number is available, mobile subscriber 121 would not have to dial any numbers. Mobile subscriber 121 could click or select the option and wireless network 100 will connect the call.

If a communication capability of mobile subscriber 122 is email, then the subscriber information also includes an email address of mobile subscriber 122. If a communication capability of mobile subscriber 122 is a chat room, then the subscriber information also includes a network address of the chat room currently occupied by mobile subscriber 122. If a communication capability of mobile subscriber 122 is a web log, then the subscriber information also includes a network address of the web log. If a communication capability of mobile subscriber 122 is a web page, then the subscriber information also includes a network address of the web page.

FIG. 3 illustrates mobile device 111 in an exemplary embodiment of the invention. Mobile device 111 comprises any device configured to communicate via wireless signals, such as a cell phone, a PDA, etc. Mobile device 111 includes a network interface 302, a processing system 304, and a user interface 306. User interface 306 is configured to provide information to and receive input from mobile subscriber 121. User interface 306 provides information to mobile subscriber 121 using a display, audio, mechanical, and/or any other interface. User interface 306 is also configured to receive input from mobile subscriber 121 through a keypad, a touch screen, a pointing device, voice input, and/or any other interface.

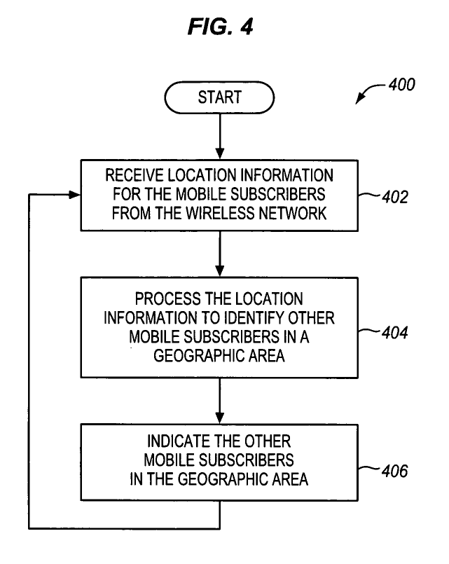

FIG. 4 is a flow chart illustrating a method 400 of operating mobile device 111 in an exemplary embodiment of the invention. The steps of method 400 will be described with reference to wireless network 100 in FIG. 1 and mobile device 111 in FIG. 3. The steps of the flow chart in FIG. 4 are not all inclusive and may include other steps not shown.

In step 402, network interface 302 receives location information from service system 106 of wireless network 100. In one embodiment, the location information may comprise the location information for all or substantially all of the mobile subscribers of wireless network 100. In another embodiment, the location information may comprise the location information for a subset of all of the mobile subscribers of wireless network 100 as determined by wireless network 100. For instance, wireless network 100 may process or filter the location information as described in FIG. 2 so that the location information provided to mobile device 111 is for other mobile subscribers found by wireless network 100 to be in a particular geographic area. In such as instance, the location information may be provided by wireless network in the form of an HTML file or another data file.

If wireless network 100 processes the location information and provides the location information in the form of an HTML file or another file that may be displayed by mobile device 111, then method 400 may skip to step 406. If wireless network 100 does not provide a displayable file, but rather provides location information to be processed by mobile device 111, then method 400 proceeds as follows.

In step 404, processing system 304 processes the location information to identify other mobile subscribers 122-124 in a geographic area. As previously described, the geographic area may be defined by being a geographic area proximate to (or in a proximity of) and/or surrounding mobile subscriber 121. The geographic area may alternatively be remote from mobile subscriber as designated by mobile subscriber 121. For instance, mobile subscriber 121 can enter a point of interest, such as an address or landmark, around which the geographic area is defined.

To identify other mobile subscribers 122-124 in a geographic area around mobile subscriber 121, processing system 304 processes the location information from wireless network 100 to determine the location of mobile subscriber 121. Processing system 304 may then determine one or more other mobile subscribers 122-124 that are in the geographic area around mobile subscriber 121. As previously discussed, the size of the geographic area may change based on the input from mobile subscriber 121, or based on the number of other mobile subscribers 122-124 found to be in the geographic area. User interface 306 can only provide a certain amount of information to mobile subscriber 121, so processing system 304 may adjust the geographic area so that the number of other mobile subscribers 122-124 found to be in the geographic area is below a threshold number.

To identify other mobile subscribers 122-124 in any other geographic area designated by mobile subscriber 121, processing system 304 may first identify a point of interest as designated by mobile subscriber 121, although the geographic area may be defined in many other ways. Processing system 304 may then identify a location of the point of interest if not already know. Processing system 304 may then process the location information from wireless network 100 to identify one or more other mobile subscribers 122-124 that are in the geographic area around the point of interest.

In step 406, processing system 304 indicates the other mobile subscribers 122-124 in the geographic area through user interface 306. Processing system 304 may display a list of the other mobile subscribers 122-124 through user interface 306. Processing system 304 may alternatively or additionally display the other mobile subscribers 122-124 on a background map through user interface 306. The map would be of the geographic area. Processing system 304 may indicate the other mobile subscribers 122-124 according to any desired visual means and/or audio means. For instance, processing system 304 may execute an application to display a browser tailored for the location-based service. If wireless network 100 provided an HTML file, then the browser can display the HTML file as provided by wireless network 100. Processing system 304 may also generate an HTML or another type of file for display by the browser.

As part of displaying the other mobile subscribers 122-124, processing system 304 may display a name of the subscribers, a nickname of the subscribers, a thumbnail picture of the subscribers, etc. Such information may be provided by wireless network 100.

Method 400 repeats as shown in FIG. 4. This is to indicate that mobile device 111 is continually updating, meaning that the information provided to mobile subscriber 121 is updated as mobile subscriber 121 is moving.

Mobile device 111 may also receive subscriber information from wireless network 100 that indicates the communication capabilities of the other mobile subscribers 122-124. Responsive to receiving the subscriber information through network interface 302, processing system 304 indicates the communication capabilities of the other mobile subscribers 122-124 to mobile subscriber 121 through user interface 306. Processing system 304 may indicate the communication capabilities in a list through user interface 306. Processing system 304 may alternatively indicate the communication capabilities as icons understood to be associated with particular communication capabilities. For instance, an icon resembling a phone may be used for voice capabilities. A “TM” icon may be used for text messaging capabilities. An “IM” icon may be used for instant messaging capabilities.

After indicating the other mobile subscribers 122-124 and possibly their corresponding communication capabilities, mobile subscriber 121 may select one or more of the other mobile subscribers 122-124 to communicate with. Selections may be made by highlighting one or more of the other mobile subscribers 122-124 indicated on user interface 306, keying in an identity of one or more of the other mobile subscribers 122-124, using voice recognition, or another interface capability provided for by user interface 306. For instance, if processing system 304 provides a list of the other mobile subscribers 122-124 through user interface 306, then mobile subscriber 121 may scroll through the list to select one or more of the other mobile subscribers 122-124.

Responsive to the selection by mobile subscriber 121, processing system 304 initiates communication with the selected other mobile subscriber 122-124. For instance, processing system 304 may initiate a call to the selected other mobile subscriber 122-124 through network interface 302. The manner in which processing system 304 initiates communication may depend on the communication capabilities of the mobile device of the selected other mobile subscriber 122-124. As an example, assume the selected other mobile subscriber is mobile subscriber 122. Further assume that processing system 304 indicates that mobile subscriber 122 has voice, instant message, and chat room capabilities. If mobile subscriber 121 chooses to the voice option, then processing system 304 initiates a call to the phone number of mobile subscriber 122. If mobile subscriber 121 chooses to the instant messaging option, then processing system 304 generates an instant message as defined by mobile subscriber 122 and transmits the instant message to wireless network 100. If mobile subscriber 121 chooses the chat room option, then processing system 304 attempts to enter the chat room currently occupied by mobile subscriber 122.

To initiate communication, processing system 304 transmits a communication request (e.g., a signaling message, a text message, etc) to wireless network 100. Wireless network 100 receives the communication request from mobile device 111, and initiates communication with one of the other mobile subscribers indicated in the communication request.

The location-based service described herein may be useful for individuals. For instance, if mobile subscriber 121 comes upon an accident on a highway, mobile subscriber 121 can identify other mobile subscribers in the area and contact one or more of the other mobile subscribers to determine if help is needed. If the accident has caused a traffic jam, mobile subscriber 121 may also contact one or more of the other mobile subscribers to find an alternate route around the accident.

The location-based service described herein may also be useful for businesses. For instance, a business can identify mobile subscribers in the area and transmit marketing information, information on specials, information on sales, etc, to the mobile subscribers. The information may be sent, for example, in the form of Really Simple Syndication (RSS) messages, which may pop up as banners on the display of the mobile devices or through a dynamically updated webpage. The business can thus provide time sensitive information to the mobile subscribers in the area.

### EXAMPLE

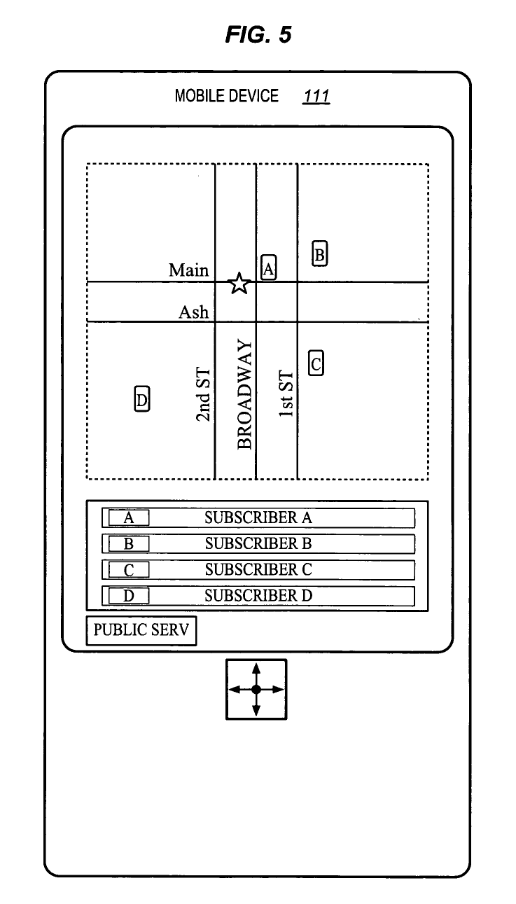

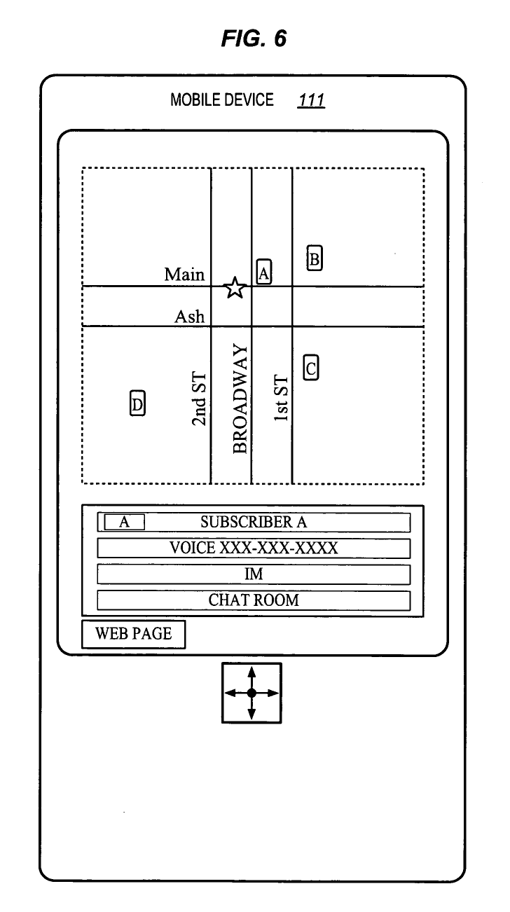

FIGS. 5-6 illustrate examples of using the location-based service according to features and aspects herein.

FIG. 5 illustrates an exemplary screen displayed by mobile device 111 in implementing the location-based service described herein. As in FIGS. 3-4, mobile device 111 receives location information from wireless network 100. In this example, mobile device 111 receives the location information in the form of an HTML file as provided by wireless network 100. The HTML file indicates one or more mobile subscribers in a particular geographic area. Mobile device 111 then displays a web page to mobile subscriber 121 based on the HTML file.

In this example, mobile device 111 displays mobile subscriber 121 on a map, which is indicated on the map by a star in FIG. 5. Mobile device 111 also displays four other mobile subscribers found to be in the geographic area, which is the geographic area around mobile subscriber 121 in this example. The other mobile subscribers in this example are Subscriber A, Subscriber B, Subscriber C, and Subscriber D. Mobile device 111 displays the location of Subscribers A-D on the map in relation to mobile subscriber 121. Mobile device 111 also displays a list of Subscribers A-D. In the list, mobile device 111 may display names of Subscribers A-D, nicknames of Subscribers A-D, thumbnail pictures of Subscribers A-D, etc.

In viewing the display of mobile device 111, mobile subscriber 121 is able to determine what other mobile subscribers or services are in his/her vicinity. Mobile subscriber 121 did not need to predefine a buddy list in order to view the other mobile subscribers, as the location information on the other mobile subscribers is provided by wireless network 100. Mobile device 111 may also include a Public Services (Public Serv) button. This button may comprise a network address to one or more public services, such as police, emergency medical, fire, weather, traffic, roadside assistance, etc.

Mobile device 111 allows mobile subscriber 121 to select one or more of Subscribers A-D in the map or in the list. Mobile subscriber 121 may view more information of the selected subscriber, such as the communication capabilities of a particular subscriber. For instance, mobile subscriber 121 may select Subscriber A.

FIG. 6 illustrates another exemplary screen displayed by mobile device 111 in implementing the location-based service described herein. Responsive to the selection of Subscriber A by mobile subscriber 121, mobile device 111 displays the communication capabilities of Subscriber A. In this example, Subscriber A as voice capabilities, Instant Messaging (IM) capabilities, and chat room capabilities. Mobile subscriber 121 may then select one of the communication capabilities to communicate with Subscriber A.

For instance, if mobile subscriber 121 selects the voice option, then mobile device 111 initiates communication with Subscriber A by calling phone number XXX-XXX-XXXX. Mobile subscriber 121 does not have to physically dial a phone number for Subscriber A, as the phone number for Subscriber A may not always be available to mobile subscriber 121. Mobile subscriber 121 can select the option to place a voice call, and wireless network 100 initiates signaling and call-processing procedures internally. Wireless network 100 stores information of Subscriber A and connects the call.

If mobile subscriber 121 selects the IM option, then mobile device 111 will provide an IM screen to mobile subscriber 121 to allow mobile subscriber 121 to compose a message. Mobile device 111 then initiates communication with Subscriber A by transmitting the message to Subscriber A based on a network address of Subscriber A or a phone number of Subscriber A.

If mobile subscriber 121 selects the chat room option, then mobile device 111 will log mobile subscriber 121 into the chat room currently occupied by Subscriber A. Mobile device 111 will also provide a chat room screen to mobile subscriber 121 that displays the present conversation in the chat room. Mobile subscriber 111 may then converse with Subscriber A in the chat room.

Mobile device 111 may also display a web page button. This button allows mobile subscriber 121 to make information public to anyone who might be interested.

Although specific embodiments were described herein, the scope of the invention is not limited to those specific embodiments. The scope of the invention is defined by the following claims and any equivalents thereof.

We claim:

1. A method of operating a wireless network to provide a location-based service to a mobile subscriber requesting the location-based service, the method comprising:
receiving location information for the mobile subscribers of the wireless network from at least one network node of the wireless network;
processing the location information to identify other mobile subscribers in a geographic area; and
transmitting the location information for the other mobile subscribers identified to be in the geographic area to the mobile device of the requesting mobile subscriber.

2. The method of claim 1 wherein the geographic area comprises a geographic area proximate to the requesting mobile subscriber or another geographic area designated by the requesting mobile subscriber.

3. The method of claim 1 further comprising:
determining communication capabilities of the other mobile subscribers; and
transmitting subscriber information indicating the communication capabilities of the other mobile subscribers to the mobile device of the requesting mobile subscriber.

4. The method of claim 3 wherein the communication capabilities include at least one of voice capabilities, text messaging capabilities, instant messaging capabilities, chat room capabilities, web log capabilities, or web page capabilities.

5. The method of claim 1 further comprising one of:
receiving an indication of the geographic area from the mobile device of the requesting mobile subscriber; or
dynamically determining the geographic area based on the number of other mobile subscribers found to be in the geographic area.

6. A method of operating a mobile device to provide a location-based service to a mobile subscriber requesting the location-based service, the method comprising:
receiving location information for mobile subscribers from a wireless network serving the mobile device;
processing the location information to identify other mobile subscribers in a geographic area; and
indicating the other mobile subscribers in the geographic area to the requesting mobile subscriber.

7. The method of claim 6 wherein the geographic area comprises a geographic area proximate to the requesting mobile subscriber or another geographic area designated by the requesting mobile subscriber.

8. The method of claim 6 further comprising:
receiving a selection of one of the other mobile subscribers by the requesting mobile subscriber; and
initiating communication with the selected other mobile subscriber.

9. The method of claim 6 further comprising:
receiving subscriber information from the wireless network indicating the communication capabilities of the other mobile subscribers; and
indicating the communication capabilities of the other mobile subscribers to the requesting mobile subscriber.

10. The method of claim 9 wherein the communication capabilities include at least one of voice capabilities, text messaging capabilities, instant messaging capabilities, chat room capabilities, web log capabilities, or web page capabilities.

11. The method of claim 9 further comprising:
receiving a selection of one of the other mobile subscribers and a selection of one of the communication capabilities of the selected other mobile subscriber by the requesting mobile subscriber; and
initiating communication with the selected other mobile subscriber based on the selected communication capability.

12. The method of claim 6 wherein indicating the other mobile subscribers comprises:
displaying a list of the other mobile subscribers.

13. The method of claim 6 wherein indicating the other mobile subscribers comprises:
displaying the other mobile subscribers on a map of the geographic area.

14. The method of claim 6 wherein the geographic area is set by the requesting mobile subscriber or is dynamically determined by the mobile device based on a number of the other mobile subscribers in the geographic area.

15. A mobile device adapted to provide a location-based service to a mobile subscriber requesting the location-based service, the mobile device comprising:
a user interface adapted to provide information to the requesting mobile subscriber and receive input from the requesting mobile subscriber; and
a processing system adapted to receive location information of mobile subscribers from a wireless network serving the mobile device, process the location information to identify other mobile subscribers in a geographic area, and indicate the other mobile subscribers in the geographic area through the user interface.

16. The mobile device of claim 15 wherein the geographic area comprises a geographic area proximate to the requesting mobile subscriber or another geographic area designated by the requesting mobile subscriber.

17. The mobile device of claim 15 wherein:
the user interface is further adapted to receive a selection of one of the other mobile subscribers by the requesting mobile subscriber; and
the processing system is further adapted to initiate communication with the selected one other mobile subscriber.

18. The mobile device of claim 15 wherein the processing system is further adapted to:
receive subscriber information from the wireless network indicating the communication capabilities of the other mobile subscribers; and
indicate the communication capabilities of the other mobile subscribers to the requesting mobile subscriber.

19. The mobile device of claim 15 wherein the processing system is further adapted to:
display a list of the other mobile subscribers through the user interface.

20. The mobile device of claim 15 wherein the processing system is further adapted to:
display the other mobile subscribers on a map of the geographic area.
